(19) United States
(12) Patent Application Publication
(10) Pub. No.: US 2021/0273243 A1
(43) Pub. Date: Sep. 2, 2021

(54) HYDROGEN SUPPLY APPARATUS AND SEALING DEVICE USED FOR SAME

(71) Applicants: Hyundai Motor Company, Seoul (KR); Kia Motors Corporation, Seoul (KR)

(72) Inventor: Byung Ryeol Lee, Yongin (KR)

(21) Appl. No.: 17/002,447

(22) Filed: Aug. 25, 2020

(30) Foreign Application Priority Data
Mar. 2, 2020 (KR) 10-2020-0025779

(51) Int. Cl. H01M 8/0276; H01M 8/04746

(52) U.S. Cl. CPC H01M 8/0278; H01M 2250/20; H01M 8/04753

(57) ABSTRACT

A hydrogen supply apparatus is provided. The apparatus includes a first connecting member having a first flow path through which hydrogen is supplied and a second connecting member connected to the first connecting member and having a second flow path that communicates with the first flow path. A back-up ring has a first packing portion abutting an inner surface of the first connecting member, a second packing portion abutting an outer surface of the second connecting member, and a connecting portion connecting ends of the first packing portion and the second packing portion. An elastic member is elastically compressible and expandable between the first and second packing portions.

### CROSS-REFERENCE TO RELATED APPLICATIONS

This application claims priority to and the benefit of Korean Patent Application No. 10-2020-0025779 filed on Mar. 2, 2020, the entire contents of which are incorporated herein by reference.

### TECHNICAL FIELD

The present disclosure relates to a hydrogen supply apparatus and a sealing device used for the same, and more particularly, to a hydrogen supply apparatus capable of improving a sealing performance and improving safety and reliability, and to a sealing device used for the same.

### BACKGROUND

A fuel cell electric vehicle (FCEV) produces electrical energy from an electrochemical reaction between oxygen and hydrogen in a fuel cell stack and uses the electrical energy as a power source. The fuel cell electric vehicle may continuously generate electricity by being supplied with fuel and air from the outside regardless of a capacity of a battery, and thus has high efficiency, and emits almost no contaminant. By virtue of these advantages, continuous research and development is being conducted on the fuel cell electric vehicle.

A plurality of hydrogen tanks are mounted within the fuel cell electric vehicle, and hydrogen is stored in the hydrogen tanks along a hydrogen charging line of a hydrogen storage system. The hydrogen stored in the hydrogen tanks is depressurized by a regulator, supplied to the fuel cell stack along a hydrogen supply line, and then used to produce electrical energy.

Meanwhile, a sealing performance of connecting parts (e.g., a regulator, a hydrogen shut-off valve, a hydrogen supply valve, and fitting parts for pipes) in the hydrogen supply line for supplying the hydrogen in the fuel cell electric vehicle is one of the most important performances related to safety of a hydrogen supply system, and particularly, safety of the entire fuel cell system.

In particular, since secondary damage such as a fire may occur when the hydrogen leaks from the connecting parts in the hydrogen supply line, leakproof sealability needs to be ensured at the connecting parts in the hydrogen supply line. In general, an O-ring made of rubber is mounted in the connecting part in the hydrogen supply line and, the leakproof sealability is maintained by the O-ring. However, in a fuel cell system in which the hydrogen is supplied at a high pressure (e.g., about 350 bar or higher), the sealing performance and the leakproof sealability are unable to be sufficiently ensured only by the O-ring.

In other words, hydrogen molecules having very small sizes may leak while penetrating (e.g., permeating) into the O-ring made of rubber under a condition in which the hydrogen is supplied at a high pressure, and damage, such as a crack, occurs to the O-ring due to the O-ring repeatedly expanding and contracting when the O-ring is repeatedly pressurized and depressurized by the hydrogen. As a result, the leakproof sealability made by the O-ring may deteriorate.

Therefore, recently, various studies are conducted to minimize a leak of hydrogen from the connecting part in the hydrogen supply line through which the hydrogen is supplied at a high pressure, and to improve stability and reliability, but the research result is still insufficient. Accordingly, there is a need for development of a hydrogen supply apparatus capable of minimizing a leak of hydrogen and improving stability and reliability.

### SUMMARY

An object of an exemplary embodiment of the present disclosure is to provide a hydrogen supply apparatus capable of improving a sealing performance and improving safety and reliability, and a sealing device used for the same. In particular, another object of the exemplary embodiment of the present disclosure is to improve an effect of sealing a connecting part in a hydrogen supply line through which hydrogen is supplied at a high pressure and to minimize a leak of hydrogen.

In addition, still another object of the exemplary embodiment of the present disclosure is to improve a sealing performance without changing a structure of a hydrogen supply line. In addition, yet another object of the exemplary embodiment of the present disclosure is to reduce a risk of a leak of hydrogen, improve durability, and extend a lifespan. The object to be achieved by the exemplary embodiment is not limited to the above-mentioned objects, but also includes objects or effects that may be recognized from the solutions or the exemplary embodiments described below.

In order to achieve the above-mentioned objects of the present disclosure, an exemplary embodiment of the present disclosure provides a hydrogen supply apparatus that may include: a first connecting member having a first flow path through which hydrogen is supplied; a second connecting member connected to the first connecting member and having a second flow path that communicates with the first flow path; a back-up ring having a first packing portion being in close contact with an inner surface of the first connecting member, a second packing portion being in close contact with an outer surface of the second connecting member, and a connecting portion that connects one end of the first packing portion and one end of the second packing portion; and an elastic member provided to be elastically compressible and expandable between the first packing portion and the second packing portion.

Accordingly, a sealing performance and safety and reliability may be improved. In other words, in the related art, an O-ring made of rubber is mounted in a connecting part in a hydrogen supply line to maintain leakproof sealability. However, in a fuel cell system in which hydrogen is supplied at a high pressure (e.g., 350 bar or higher), the sealing performance and the leakproof sealability are unable to be sufficiently ensured only by the O-ring.

In contrast, in the exemplary embodiment of the present disclosure, the elastic member, which is provided to elastically expand between the first packing portion and the second packing portion, brings the first packing portion into close or abutting contact with the inner surface of the first connecting member and brings the second packing portion into close or abutting contact with the outer surface of the second connecting member, and as a result, it is possible to obtain an advantageous effect of increasing a sealing performance and improving leakproof sealability.

Above all, according to the exemplary embodiment of the present disclosure, it may be possible to obtain an advantageous effect of reducing a risk of a leak of hydrogen from a connecting part in a hydrogen supply line through which hydrogen is supplied at a high pressure, improving durability, and improving safety and reliability. According to the exemplary embodiment of the present disclosure, an inner surface of the first packing portion, an inner surface of the second packing portion, and an inner surface of the connecting portion may cooperatively define a receiving groove, and the elastic member may be received in the receiving groove to be disposed between the first packing portion and the second packing portion.

According to the exemplary embodiment of the present disclosure, the first packing portion may be provided to be elastically movable relative to the connecting portion, and the elastic member may elastically compress and expand in accordance with the movement of the first packing portion. In particular, the first packing portion may be inclined with respect to the inner surface of the first connecting member, and the first packing portion may compress the elastic member while elastically moving relative to the connecting portion when the first packing portion is pressed by the inner surface of the first connecting member.

As described above, the first packing portion may be inclined with respect to the inner surface of the first connecting member, and thus, when the second connecting member is inserted into the first connecting member, the first packing portion is pressed by the inner surface of the first connecting member to compress the elastic member. As a result, in the state in which the back-up ring is disposed in the gap between the first connecting member and the second connecting member, both restoring force (e.g., force for restoring the first packing portion to an initial state in which the first packing portion is not pressed) of the first packing portion and restoring force (e.g., force for restoring the elastic member to an initial state before the elastic member is compressed) of the elastic member may be applied to the first packing portion, such that the first packing portion may be brought more effectively into close contact with the inner surface of the first connecting member.

Therefore, it may be possible to obtain an advantageous effect of improving a sealing effect and a sealing performance implemented by the back-up ring and more effectively inhibiting hydrogen from leaking through the gap between the first connecting member and the second connecting member. In addition, when the pressure of the hydrogen supplied along the first connecting member and the second connecting member increases to a predetermined pressure or higher when the back-up ring is disposed in the gap between the first connecting member and the second connecting member, expansive force of the elastic member, together with the restoring force of the first packing portion and the restoring force of the elastic member, may also be applied to the first packing portion. As a result, it may be possible to obtain an advantageous effect maximizing the sealing performance implemented by the back-up ring and improving safety and reliability.

According to the exemplary embodiment of the present disclosure, the second packing portion may be formed in parallel with the outer surface of the second connecting member. Since the second packing portion may be formed in parallel with the outer surface of the second connecting member as described above, it may be possible to obtain an advantageous effect of more easily performing a process of disposing the back-up ring on the outer surface of the second connecting member, and to obtain an advantageous effect of stably maintaining the state in which the back-up ring is disposed with respect to the second connecting member. According to another exemplary embodiment of the present disclosure, the second packing portion may be inclined with respect to the outer surface of the second connecting member.

The elastic member may selectively expand based on a pressure of the hydrogen supplied along the first connecting member and the second connecting member. In particular, the back-up ring and the elastic member may be made of different materials. As an example, the elastic member may be made of an elastomer and the back-up ring may be made of plastic resin. The sealing device may include a sealing member that seals a gap between the first connecting member and the second connecting member.

Additionally, the gap between the first connecting member and the second connecting member may be sealed by the dual sealing structure implemented by the sealing member and the back-up ring, and as a result, it may be possible to obtain an advantageous effect of effectively inhibiting hydrogen from leaking through the gap between the first connecting member and the second connecting member. Furthermore, the sealing performance implemented by the back-up ring may be maintained even though damage, such as a crack, occurs to the sealing member when the sealing member repeatedly expands and contracts. As a result, it may be possible to obtain an advantageous effect of reducing a risk of a leak of hydrogen and improving safety and reliability.

According to the exemplary embodiment of the present disclosure, a seating groove may be formed in the outer surface of the second connecting member, and the back-up ring and the sealing member may be received in the seating groove. As described above, since the recessed seating groove may be formed in the outer surface of the second connecting member and the back-up ring and the sealing member may be received in the seating groove, it may be possible to obtain an advantageous effect of inhibiting the withdrawal of the back-up ring and the sealing member and maintaining the stable arranged state of the back-up ring and the sealing member.

The seating groove may be formed to have various structures in accordance with required conditions and design specifications. As an example, the seating groove may include: a bottom portion being in close or abutting contact with the second packing portion; a first vertical wall portion formed at a first end of the bottom portion; and a second vertical wall portion formed at a second end of the bottom portion.

Another exemplary embodiment of the present disclosure provides a sealing device configured to seal a gap between a first connecting member and a second connecting member connected to the first connecting member, the sealing device may include: a back-up ring having a first packing portion in abutting contact with an inner surface of the first connecting member, a second packing portion in abutting contact with an outer surface of the second connecting member, and a connecting portion configured to connect one end of the first packing portion and one end of the second packing portion; and an elastic member provided to be elastically compressible and expandable between the first packing portion and the second packing portion.

According to the exemplary embodiment of the present disclosure, an inner surface of the first packing portion, an inner surface of the second packing portion, and an inner surface of the connecting portion may cooperatively define a receiving groove, and the elastic member may be received in the receiving groove. According to the exemplary embodiment of the present disclosure, the first packing portion may be provided to be elastically movable relative to the connecting portion, and the elastic member may elastically compress and expand in accordance with the movement of the first packing portion.

According to the exemplary embodiment of the present disclosure, the first packing portion may be inclined with respect to the inner surface of the first connecting member, and the first packing portion may compress the elastic member while elastically moving relative to the connecting portion when the first packing portion is pressed by the inner surface of the first connecting member. The second packing portion may be formed in parallel with the outer surface of the second connecting member. Additionally, the elastic member may selectively expand based on a pressure of the hydrogen supplied along the first connecting member and the second connecting member.

Further, the back-up ring may be made of plastic resin, and the elastic member may be made of an elastomer. According to the exemplary embodiment of the present disclosure, the sealing device may include a sealing member that seals a gap between the first connecting member and the second connecting member.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a view for explaining a hydrogen supply apparatus according to an exemplary embodiment of the present disclosure.

FIG. 2 is an enlarged view of part ‘A’ in FIG. 1 according to an exemplary embodiment of the present disclosure.

FIG. 3 is a perspective view for explaining a sealing device in the hydrogen supply apparatus according to the exemplary embodiment of the present disclosure.

FIG. 4 is a side view for explaining the sealing device in the hydrogen supply apparatus according to the exemplary embodiment of the present disclosure.

FIGS. 5 and 6 are views for explaining structures of back-up rings in the hydrogen supply apparatus according to the exemplary embodiment of the present disclosure.

FIG. 7 is a view for explaining a sealing structure made by the sealing device in the hydrogen supply apparatus according to the exemplary embodiment of the present disclosure.

FIGS. 8 and 9 are views for explaining modified examples of the sealing device in the hydrogen supply apparatus according to the exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. However, the technical spirit of the present disclosure is not limited to some exemplary embodiments described herein but may be implemented in various different forms. One or more of the constituent elements in the exemplary embodiments may be selectively combined and substituted within the scope of the technical spirit of the present disclosure.

In addition, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the exemplary embodiment of the present disclosure are for explaining the exemplary embodiments, not for limiting the present disclosure. Unless particularly stated otherwise in the present specification, a singular form also includes a plural form. The explanation “at least one (or one or more) of A, B, and C” described herein may include one or more of all combinations that can be made by combining A, B, and C. In addition, the terms first, second, A, B, (a), and (b) may be used to describe constituent elements of the exemplary embodiments of the present disclosure.

These terms are used only for the purpose of discriminating one constituent element from another constituent element, and the nature, the sequences, or the orders of the constituent elements are not limited by the terms. Further, the explanation “one constituent element is described as being ‘connected’, ‘coupled’, or ‘attached’ to another constituent element”, may include not only a case in which one constituent element can be connected, coupled, or attached directly to another constituent element, but also a case in which one constituent element and another constituent element can be ‘connected’, ‘coupled’, or ‘attached’ by an additional constituent element intervening between one constituent element and another constituent element.

In addition, the explanation “one constituent element is formed or disposed above (on) or below (under) another constituent element” includes not only a case in which the two constituent elements are in direct contact with each other, but also a case in which one or more additional constituent elements are formed or disposed between the two constituent elements. In addition, the expression “up (above) or down (below)” may include a meaning of a downward direction as well as an upward direction based on one constituent element.

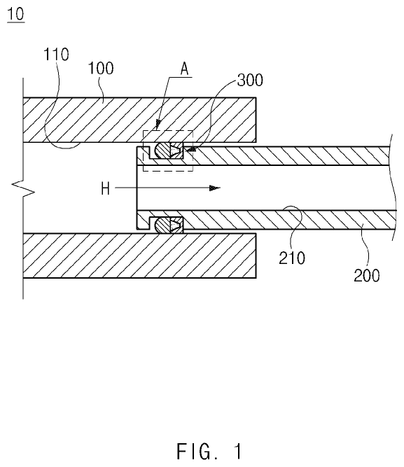

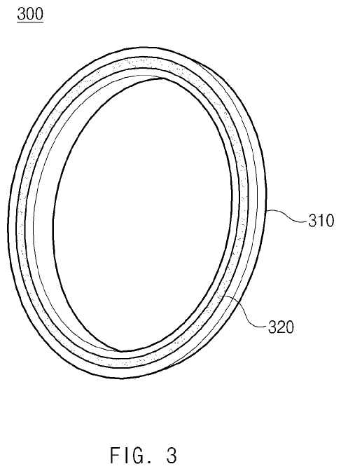

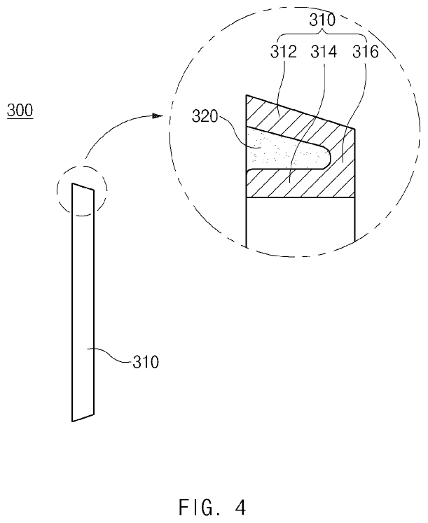

Referring to FIGS. 1 to 7, a hydrogen supply apparatus 10 according to an exemplary embodiment of the present disclosure may include: a first connecting member 100 having a first flow path 110 through which hydrogen is supplied; a second connecting member 200 connected to the first connecting member 100 and having a second flow path 210 that communicates with the first flow path 110; and a sealing device 300 that seals a gap between the first connecting member 100 and the second connecting member 200 connected to the first connecting member 100. The sealing device 300 may include a back-up ring 310 having a first packing portion 312 in close or abutting contact with an inner surface of the first connecting member 100, a second packing portion 314 in close or abutting contact with an outer surface of the second connecting member 200, and a connecting portion 316 that connects one end of the first packing portion 312 and one end of the second packing portion 314; and an elastic member 320 provided to be elastically compressible and expandable between the first packing portion 312 and the second packing portion 314.

For reference, the hydrogen supply apparatus 10 according to the exemplary embodiment of the present disclosure may be used to supply hydrogen in a fuel cell electric vehicle or other devices or facilities. The present disclosure is not restricted or limited by types and structures of subjects to be mounted in the hydrogen supply apparatus 10. As an example, the hydrogen supply apparatus 10 according to the exemplary embodiment of the present disclosure may be provided to define a hydrogen supply line in a fuel cell electric vehicle.

According to the exemplary embodiment of the present disclosure, the fuel cell electric vehicle (not illustrated) includes a hydrogen tank (not illustrated) that stores hydrogen, and the first connecting member 100 and the second connecting member 200 may be provided to supply a fuel cell stack (not illustrated) with the hydrogen stored in the hydrogen tank. According to another exemplary embodiment of the present disclosure, the first connecting member 100 and the second connecting member 200 may be used to supply the hydrogen tank with the hydrogen provided by a receptacle.

Particularly, the first connecting member 100 and the second connecting member 200 may be components such as a regulator, a hydrogen shut-off valve, a hydrogen supply valve, and pipes that form a hydrogen supply line (e.g., a hydrogen supply line in a fuel cell electric vehicle) through which hydrogen is supplied. The present disclosure is not restricted or limited by types, structures, and arrangement structures of the first connecting member 100 and the second connecting member 200. As an example, the first connecting member 100 may be a hydrogen valve configured to adjust a supply of high-pressure hydrogen, and the second connecting member 200 may be a pipe (or a pipe connecting member 316) connected to the first connecting member 100.

The first connecting member 100 has the first flow path 110 through which the hydrogen is supplied. A connecting aperture (not illustrated), which communicates with the first flow path 110, may be formed at one side of the first connecting member 100. The second connecting member 200 has the second flow path 210 through which the hydrogen is supplied, and one end of the second connecting member 200 may be received in the connecting aperture formed in the first connecting member 100. The first flow path 110 and the second flow path 210 communicate with each other in the state in which one end of the second connecting member 200 is received in the connecting aperture formed in the first connecting member 100.

The first flow path 110 and the second flow path 210 may be connected to each other in a straight or curved shape, but the present disclosure is not restricted or limited by a connection structure between the first flow path 110 and the second flow path 210. For reference, the fuel cell stack may be formed to have various structures capable of producing electricity by an oxidation-reduction reaction between fuel (e.g., hydrogen) and an oxidant (e.g., air).

As an example, the fuel cell stack may include: a membrane electrode assembly (MEA) (not illustrated) having catalyst electrode layers, in which electrochemical reactions occur, at both sides of an electrolyte membrane through which hydrogen ions move; a gas diffusion layer (GDL) (not illustrated) configured to uniformly distribute reactant gases and transfer generated electrical energy; a gasket (not illustrated) and a fastener (not illustrated) configured to maintain leakproof sealability for the reactant gases and a coolant and maintain an appropriate fastening pressure; and a separator (bipolar plate) (not illustrated) configured to move the reactant gases and the coolant.

More specifically, in the fuel cell stack, hydrogen, which is fuel, and air (oxygen), which is an oxidant, are supplied to an anode and a cathode of the membrane electrode assembly, respectively, through flow paths in the separator, such that the hydrogen is supplied to the anode, and the air is supplied to the cathode. The hydrogen supplied to the anode is decomposed into hydrogen ions (protons) and electrons by catalysts in the electrode layers provided at both sides of the electrolyte membrane. Only the hydrogen ions are selectively delivered to the cathode through the electrolyte membrane which is a positive ion exchange membrane, and at the same time, the electrons are delivered to the cathode through the gas diffusion layer and the separator which are conductors.

At the cathode, the hydrogen ions supplied through the electrolyte membrane and the electrons delivered through the separator meet oxygen in the air supplied to the cathode by an air supply device to create a reaction of producing water. Due to the movement of the hydrogen ions, the electrons flow through external conductive wires, and an electric current is produced due to the flow of the electrons.

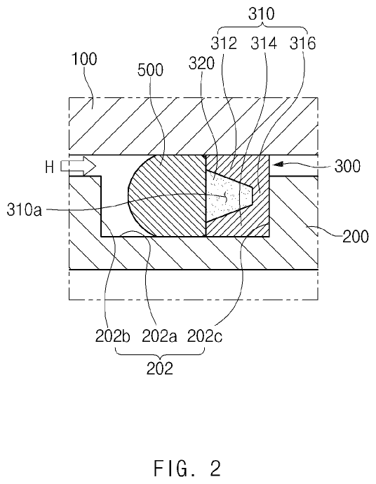

Referring to FIGS. 2 to 7, the sealing device 300 is provided to seal a gap between the first connecting member 100 and the second connecting member 200 connected to the first connecting member 100. More specifically, the sealing device 300 may include a back-up ring 310 having the first packing portion 312 in abutting contact with the inner surface (e.g., an inner circumferential surface) of the first connecting member 100, the second packing portion 314 in abutting contact with the outer surface (e.g., an outer circumferential surface) of the second connecting member 200, and a connecting portion 316 that connects one end of the first packing portion 312 and one end of the second packing portion 314. The sealing device 300 may further include an elastic member 320 provided to be elastically compressible and expandable between the first packing portion 312 and the second packing portion 314.

The back-up ring 310 may be disposed in the gap between the first connecting member 100 and the second connecting member 200 received in the first connecting member 100 (e.g., a connecting part). The back-up ring 310 may be formed in the form of a ring continuously connected in a circumferential direction of the first connecting member 100 (or the second connecting member) and may seal the gap between the first connecting member 100 and the second connecting member 200.

More specifically, the back-up ring 310 may be formed to have an approximately “U”-shaped cross-section and may include the first packing portion 312 in abutting contact with the inner surface of the first connecting member 100, the second packing portion 314 in abutting contact with the outer surface of the second connecting member 200, and the connecting portion 316 that integrally connects one end of the first packing portion 312 and one end of the second packing portion 314.

The first packing portion 312 may include a first outer surface in abutting contact with the inner surface of the first connecting member 100, and a first inner surface facing the outer surface of the second connecting member 200. The second packing portion 314 may include a second outer surface in abutting contact with the outer surface of the second connecting member 200, and a second inner surface facing the outer surface of the first connecting member 100.

The back-up ring 310 may be made of various materials so that the back-up ring 310 may be in abutting contact with the inner surface of the first connecting member 100 and the outer surface of the second connecting member 200. The present disclosure is not restricted or limited by a material of the back-up ring 310. The back-up ring 310 may be made of a non-gas-permeable material unable transmit gas (hydrogen). As an example, the back-up ring 310 may be made of plastic resin that cannot transmit hydrogen.

The elastic member 320 is made of a different material from the back-up ring 310 and provided to be elastically compressible and expandable between the first packing portion 312 and the second packing portion 314. The elastic member 320, together with the back-up ring 310, may be formed by dual-injection molding or may be joined to the back-up ring 310 by a separate bonding layer. A method of joining the elastic member 320 and the back-up ring 310 may be variously changed based on required conditions and design specifications.

An inner surface of the first packing portion 312, an inner surface of the second packing portion 314, and an inner surface of the connecting portion 316 may cooperatively define a receiving groove 310a, and the elastic member 320 is received in the receiving groove 310a to be disposed between the first packing portion 312 and the second packing portion 314. The receiving groove 310a may have various forms and structures capable of receiving the elastic member 320, and the present disclosure is not restricted or limited by forms and structures of the receiving groove 310a. As an example, the receiving groove 310a may be formed in the form of a ring having an approximately trapezoidal cross section, and the elastic member 320 may be formed in the form of a ring having a trapezoidal cross section corresponding to the receiving groove 310a.

An opening portion of the receiving groove 310a may be disposed to be directed in a direction in which high-pressure hydrogen H is supplied. Since the opening portion of the receiving groove 310a is directed in the direction in which the high-pressure hydrogen is supplied, as described above, the elastic member 320 received in the receiving groove 310a may be exposed to the high-pressure hydrogen through the opening portion of the receiving groove 310a. The elastic member 320 may be made of various materials that may compress and expand based on a pressure of the hydrogen supplied along the first connecting member 100 and the second connecting member 200. The present disclosure is not restricted or limited by materials and types of the elastic member 320.

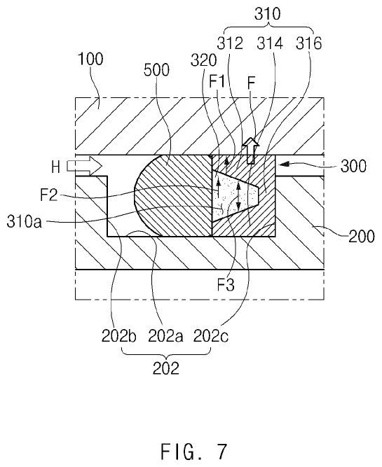

As an example, the elastic member 320 may be made of an elastomer (EPDM) (e.g., rubber) into which hydrogen molecules may penetrate. When the pressure of the hydrogen supplied along the first connecting member 100 increases to a predetermined pressure or higher, the hydrogen molecules penetrate into the elastic member 320, and thus, the elastic member 320 may expand. When the elastic member 320 expands as described above, the first packing portion 312 and the second packing portion 314 are moved away from each other by expansive force (F3 in FIG. 7) of the elastic member 320 (e.g., the first packing portion 312 is moved upward and the second packing portion 314 is moved downward based on FIG. 2), and thus, the first packing portion 312 may be in closer contact with the inner surface of the first connecting member 100, and the second packing portion 314 may be in closer contact with the outer surface of the second connecting member 200.

According to the exemplary embodiment of the present disclosure as described above, the elastic member 320 may be disposed between the first packing portion 312 and the second packing portion 314, and the elastic member 320 expands as the hydrogen molecules penetrate into the elastic member 320 when the pressure of the hydrogen supplied along the first connecting member 100 increases to a predetermined pressure or higher, and thus, the expansive force (F3 in FIG. 7) of the elastic member 320 may bring the first packing portion 312 into closer contact with the inner surface of the first connecting member 100 and bring the second packing portion 314 into closer contact with the outer surface of the second connecting member 200. As a result, it may be possible to obtain an advantageous effect of improving the sealing performance implemented by the back-up ring 310 and more effectively inhibiting the hydrogen from being exposed to the gap between the first connecting member 100 and the second connecting member 200.

In particular, the first packing portion 312 may be elastically movable relative to the connecting portion 316, and the elastic member 320 may elastically compress and expand based on the movement of the first packing portion 312. The configuration in which the first packing portion 312 elastically moves relative to the connecting portion 316 indicates that based on a first end of the first packing portion 312 connected to the connecting portion 316, a second end of the first packing portion 312 elastically moves toward or away from the second packing portion 314.

When the second end of the first packing portion 312 moves toward the second packing portion 314 based on the first end of the first packing portion 312 connected to the connecting portion 316, the elastic member 320 may be compressed. On the contrary, when the second end of the first packing portion 312 moves away from the second packing portion 314 based on the first end of the first packing portion 312 connected to the connecting portion 316, the elastic member 320 may expand.

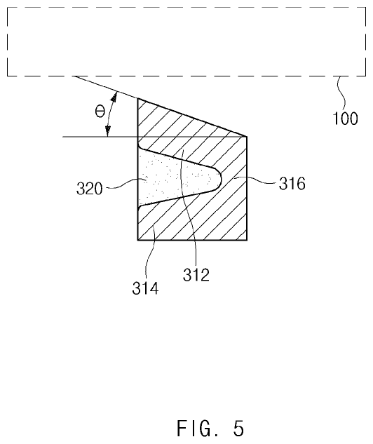

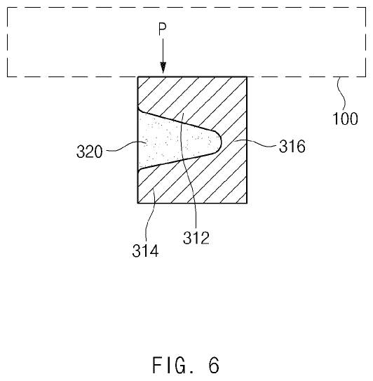

In particular, referring to FIGS. 5 and 6, the first packing portion 312 may be inclined at a predetermined angle θ with respect to the inner surface of the first connecting member 100, and the first packing portion 312 may compress the elastic member 320 while elastically moving relative to the connecting portion 316 when the first packing portion 312 is pressed by the inner surface of the first connecting member 100.

As described above, the first packing portion 312 may be inclined with respect to the inner surface of the first connecting member 100 (e.g., a left end of the first packing portion further protrudes upward than a right end of the first packing portion based on FIG. 5), such that when the second connecting member 200 is inserted into the first connecting member 100, the first packing portion 312 is pressed (P) by the inner surface of the first connecting member 100 to compress the elastic member 320. As a result, when the back-up ring 310 is disposed in the gap between the first connecting member 100 and the second connecting member 200, both restoring force (e.g., force for restoring the first packing portion to an initial state in which the first packing portion is not pressed) F1 of the first packing portion 312 and restoring force (e.g., force for restoring the elastic member to an initial state before the elastic member is compressed) F2 of the elastic member 320 may be applied to the first packing portion 312, such that the first packing portion 312 may be more effectively in close contact with the inner surface of the first connecting member 100.

Therefore, it may be possible to obtain an advantageous effect of improving a sealing effect and a sealing performance implemented by the back-up ring 310 and more effectively inhibiting hydrogen from leaking through the gap between the first connecting member 100 and the second connecting member 200.

In addition, as illustrated in FIG. 7, when the pressure of the hydrogen supplied along the first connecting member 100 and the second connecting member 200 increases to a predetermined pressure or higher in the state in which the back-up ring 310 is disposed in the gap between the first connecting member 100 and the second connecting member 200, expansive force F3 of the elastic member 320, together with the restoring force F1 of the first packing portion 312 and the restoring force F2 of the elastic member 320, may also be applied (F) to the first packing portion 312. As a result, it may be possible to obtain an advantageous effect of maximizing the sealing performance implemented by the back-up ring 310 and improving safety and reliability.

In contrast, the second packing portion 314 may be formed in parallel with the outer surface of the second connecting member 200. Since the second packing portion 314 may be formed in parallel with the outer surface of the second connecting member 200 as described above, it may be possible to obtain an advantageous effect of easily performing a process of disposing the back-up ring 310 on the outer surface of the second connecting member 200, and to obtain an advantageous effect of stably maintaining the state in which the back-up ring 310 is disposed with respect to the second connecting member 200. According to another exemplary embodiment of the present disclosure, the second packing portion 314 may be inclined with respect to the outer surface of the second connecting member 200, similar to the first packing portion 312.

According to the exemplary embodiment of the present disclosure, the sealing device 300 may include a sealing member 500 that seals the gap between the first connecting member 100 and the second connecting member 200. In particular, the sealing member 500 may be disposed adjacent to a lateral portion of the back-up ring 310 and may form a dual sealing structure together with the back-up ring 310. An O-ring made of an elastomer (EPDM) such as rubber may be used as the sealing member 500, but the present disclosure is not restricted or limited by materials and structures of the sealing member 500.

According to the exemplary embodiment of the present disclosure as described above, the gap between the first connecting member 100 and the second connecting member 200 may be sealed by the dual sealing structure implemented by the sealing member 500 and the back-up ring 310, and as a result, it may be possible to obtain an advantageous effect of effectively inhibiting hydrogen from leaking through the gap between the first connecting member 100 and the second connecting member 200.

Furthermore, the sealing performance implemented by the back-up ring 310 may be maintained even though there occurs damage to the sealing member 500 such as a crack when the sealing member 500 repeatedly expands and shrinks. As a result, it may be possible to obtain an advantageous effect of reducing a risk of a leak of hydrogen and improving safety and reliability.

Meanwhile, according to the exemplary embodiment of the present disclosure, a seating groove 202 may be formed in the outer surface of the second connecting member 200, and the back-up ring 310 and the sealing member 500 may be received in the seating groove 202. Since the recessed seating groove 202 is formed in the outer surface of the second connecting member 200 and the back-up ring 310 and the sealing member 500 are received in the seating groove 202, it may be possible to obtain an advantageous effect of inhibiting the withdrawal of the back-up ring 310 and the sealing member 500 and stably maintaining the arranged state of the back-up ring 310 and the sealing member 500.

The seating groove 202 may be formed to have various structures in accordance with required conditions and design specifications. As an example, the seating groove 202 may be formed in the form of a quadrangular groove including a bottom portion 202a in abutting contact with the second packing portion 314, a first vertical wall portion 202b formed at a first end of the bottom portion 202a, and a second vertical wall portion 202c formed at a second end of the bottom portion 202a.

According to the exemplary embodiment of the present disclosure as described above, it may be possible to ensure the sealing performance implemented by the back-up ring 310 without changing the existing structure of the seating groove 202 (e.g., without inclining the wall portion of the seating groove 202 which comes into contact with the back-up ring 310 to be in abutting contact with the back-up ring 310), and as a result, it may be possible to obtain an advantageous effect of simplifying a structure and a manufacturing process.

Meanwhile, in the exemplary embodiment of the present disclosure described above and illustrated in the drawings, the configuration in which the receiving groove 310a is formed in the form of a ring having an approximately trapezoidal cross section and the elastic member 320 is formed in the form of a ring having a trapezoidal cross section corresponding to the receiving groove 310a is described as an example. However, the receiving groove and the elastic member may be formed in other forms as long as the first packing portion (or the second packing portion) may elastically move relative to the connecting portion.

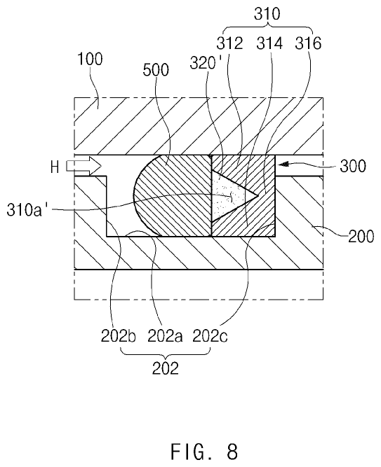

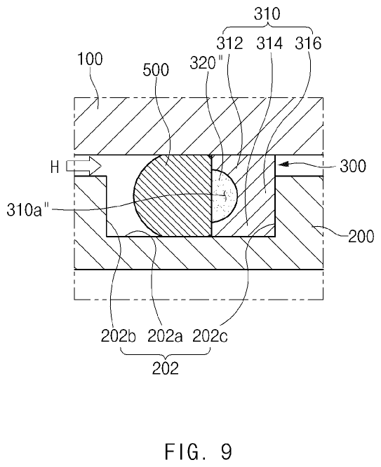

As an example, referring to FIG. 8, a receiving groove 310a′ may be formed in the form of a ring having an approximately triangular cross section, and an elastic member 320′ may be formed in the form of a ring having a triangular cross section corresponding to the receiving groove 310a′. As another example, as illustrated in FIG. 9, a receiving groove 310a″ may be formed in the form of a ring having an approximately semicircular cross section, and an elastic member 320″ may be formed in the form of a ring having a semicircular cross section corresponding to the receiving groove 310a″.

While the exemplary embodiments have been described above, but the exemplary embodiments are just illustrative and not intended to limit the present disclosure. It can be appreciated that various modifications and alterations, which are not described above, may be made to the present exemplary embodiment by those skilled in the art without departing from the intrinsic features of the present exemplary embodiment. For example, the respective constituent elements specifically described in the exemplary embodiments may be modified and then carried out. Further, it should be interpreted that the differences related to the modifications and alterations are included in the scope of the present disclosure defined by the appended claims.

According to the exemplary embodiment of the present disclosure as described above, it is possible to obtain an advantageous effect of improving the sealing performance and improving safety and reliability. In particular, according to the exemplary embodiment of the present disclosure, it is possible to obtain an advantageous effect of improving an effect of sealing the connecting part in the hydrogen supply line through which the hydrogen is supplied, and to obtain an advantageous effect of minimizing a leak of hydrogen.

In addition, according to the exemplary embodiment of the present disclosure, it is possible to obtain an advantageous effect of improving the sealing performance without changing the structure of the hydrogen supply line. In addition, according to the exemplary embodiment of the present disclosure, it is possible to obtain an advantageous effect of reducing a risk of a leak of hydrogen, improving durability, and extending a lifespan.

What is claimed is:

1. A hydrogen supply apparatus, comprising:
a first connecting member having a first flow path through which hydrogen is supplied;
a second connecting member connected to the first connecting member and having a second flow path that communicates with the first flow path;
a back-up ring having a first packing portion in abutting contact with an inner surface of the first connecting member, a second packing portion in abutting contact with an outer surface of the second connecting member, and a connecting portion that connects one end of the first packing portion and one end of the second packing portion; and
an elastic member elastically compressible and expandable between the first packing portion and the second packing portion.

2. The hydrogen supply apparatus of claim 1, wherein an inner surface of the first packing portion, an inner surface of the second packing portion, and an inner surface of the connecting portion cooperatively define a receiving groove, and the elastic member is received in the receiving groove.

3. The hydrogen supply apparatus of claim 1, wherein the first packing portion is elastically movable relative to the connecting portion, and the elastic member elastically compresses and expands based on movement of the first packing portion.

4. The hydrogen supply apparatus of claim 3, wherein the first packing portion is inclined with respect to the inner surface of the first connecting member, and the first packing portion compresses the elastic member while elastically moving relative to the connecting portion when the first packing portion is pressed by the inner surface of the first connecting member.

5. The hydrogen supply apparatus of claim 4, wherein the second packing portion is formed in parallel with the outer surface of the second connecting member.

6. The hydrogen supply apparatus of claim 3, wherein the elastic member selectively expands based on a pressure of the hydrogen supplied along the first connecting member and the second connecting member.

7. The hydrogen supply apparatus of claim 6, wherein the back-up ring and the elastic member are made of different materials.

8. The hydrogen supply apparatus of claim 7, wherein the back-up ring is made of plastic resin, and the elastic member is made of an elastomer.

9. The hydrogen supply apparatus of claim 1, further comprising:
a sealing member configured to seal a gap between the first connecting member and the second connecting member.

10. The hydrogen supply apparatus of claim 9, wherein a seating groove is formed in the outer surface of the second connecting member, and the back-up ring and the sealing member are received in the seating groove.

11. The hydrogen supply apparatus of claim 10, wherein the seating groove include:
a bottom portion being in abutting contact with the second packing portion;
a first vertical wall portion formed at a first end of the bottom portion; and
a second vertical wall portion formed at a second end of the bottom portion.

12. A sealing device configured to seal a gap between a first connecting member and a second connecting member connected to the first connecting member, the sealing device comprising:
a back-up ring including a first packing portion in abutting contact with an inner surface of the first connecting member, a second packing portion in abutting contact with an outer surface of the second connecting member, and a connecting portion that connects one end of the first packing portion and one end of the second packing portion; and
an elastic member elastically compressible and expandable between the first packing portion and the second packing portion.

13. The sealing device of claim 12, wherein an inner surface of the first packing portion, an inner surface of the second packing portion, and an inner surface of the connecting portion cooperatively define a receiving groove, and the elastic member is received in the receiving groove.

14. The sealing device of claim 13, wherein the first packing portion is elastically movable relative to the connecting portion, and the elastic member elastically compresses and expands based on movement of the first packing portion.

15. The sealing device of claim 14, wherein the first packing portion is inclined with respect to the inner surface of the first connecting member, and the first packing portion compresses the elastic member while elastically moving relative to the connecting portion when the first packing portion is pressed by the inner surface of the first connecting member.

16. The sealing device of claim 15, wherein the second packing portion is formed in parallel with the outer surface of the second connecting member.

17. The sealing device of claim 14, wherein the elastic member selectively expands based on a pressure of the hydrogen supplied along the first connecting member and the second connecting member.

18. The sealing device of claim 17, wherein the back-up ring is made of plastic resin, and the elastic member is made of an elastomer.

19. The sealing device of claim 12, further comprising:
a sealing member configured to seal a gap between the first connecting member and the second connecting member.
